(19) United States
(12) Patent Application Publication
(10) Pub. No.: US 2024/0307811 A1
(43) Pub. Date: Sep. 19, 2024

(54) DEVICE FOR SEPARATING CO2 FROM THE AMBIENT AIR AND ABSORBING CONCENTRATED CO2

(71) Applicants: Kolja KUSE, Muenchen (DE); Joerg FREIHERR VON UND ZU WEILER, Leese (DE); Philip PETRASCH, Caprino. Vse (IT)

(72) Inventors: Kolja KUSE, Muenchen (DE); Joerg FREIHERR VON UND ZU WEILER, Leese (DE); Philip PETRASCH, Caprino, Vse (IT)

(21) Appl. No.: 18/024,937

(22) PCT Filed: Sep. 6, 2021
(86) PCT No.: PCT/EP2021/000105

§ 371 Date: Mar. 6, 2023

(30) Foreign Application Priority Data
Sep. 6, 2020 (DE) 202020003779.6

(51) Int. Cl. B01D 53/04; B01D 46/00; B01D 53/02; B01J 20/10; C05D 9/00

(52) U.S. Cl. CPC B01D 53/0407; B01D 46/0034; B01D 46/0036; B01D 53/025; B01J 20/10; C05D 9/00; B01D 2253/10; B01D 2257/504

(57) ABSTRACT

The invention describes a housing which aerates stone dust with ambient air or stone dust in an aqueous solution with concentrated CO2, the stone dust having a defined degree of humidity in order to absorb CO2. So that the stone dust does not escape from inside the housing, a plate system with a filter ensures that the stone dust is fixed in a certain position in the container.

So that the stone dust, which is moistened with the help of water mist in the supply air, does not clump and can be aerated more efficiently, the plates are partially in a state of vibration, which is generated by a frequency-controlled vibrating mechanism.

To empty the housing, the arrangement is pivoted through 180° and opened.

Preferred stones for the aeration material are granite, gneiss, gabbro and basalt rocks. Under certain circumstances, metallic parts are removed with a magnet so that the stone dust material can be used as fertilizer.

The present invention relates to the collection and separation of CO2 from ambient air or from carbonic acid consisting of CO2 solution in water. Dusts from certain stone materials are used as filter material, together with auxiliary filters.

Such systems are already being used for so-called direct air capture, in which, for example, ambient air meets a diaphragm that uses electrical energy to filter the CO2 out of the air. CO2 collectors selectively capture carbon dioxide in two steps. First, air is sucked into the collector with a fan. Carbon dioxide is caught on the surface of a highly selective filter material located in the collectors. When the filter material is filled with carbon dioxide, the collector is closed. Raising the temperature to around 100° C. releases the carbon dioxide again and collects the high-purity, high-concentration carbon dioxide.

Such systems are operated with a considerable amount of electrical energy. The advantage is that the CO2 is available in its pure form for further processing after the process.

In cases where this is not necessary and the CO2 is simply to be collected and permanently stored in some form, significantly less energy is required. The prerequisite for this is that after the CO2 has been collected, the filter material is stored together with the carbon dioxide for as long and permanently as possible in the earth or in the soil or on the bottom of oceans or is otherwise stored or stored in some way, or is mixed with the soil on arable land.

According to the latest scientific findings, stone materials can serve as filter material, which are exposed to artificial weathering by air and water containing carbon dioxide or water containing carbon dioxide-such as carbonic acid.

These stone materials should be as fine-grained as possible in order to be able to absorb the carbon dioxide as quickly as possible. In addition, these stone materials with the largest possible surface should have the largest possible contact with the CO2-containing ambient air or the CO2-containing water in order to accelerate the weathering process. In addition, the equipment required for this should be as inexpensive and simple as possible and be able to be operated with as little energy as possible.

For this purpose, the invention proposes a container or container with filter or filters, which is filled with moistened stone dust from the ambient air, the stone dust having a defined degree of water humidity, in order to filter CO2 from the air in cooperation with water or water mist. So that the surface of the stone dust exposed to the ambient air is as large as possible, the bottom of the container should be flat and level and made of a material that does not rust. The filter should be fine enough to carry and collect the stone dust as it dries. Air is blown through the filter, either by free flow of air or, to speed up the process, by forced ventilation. Since the carbonation of the stone dust only works in the presence of water, the air flow must have at least a certain amount of moisture, which is added when the initially wet stone dust in the form of stone mud becomes too dry. So that the stone mud or stone dust does not solidify and clump together, the container can have a mechanical shaking device. By alternately or simultaneously shaking and blowing air through the container with filter, the air flow through the stone dust is optimized and weathering is accelerated. The vibration frequency, depending on the water content and stone dust grain size, plays a decisive role in the rate of weathering.

The container is horizontal, with the filter on the bottom and the blower on the bottom. The container is filled with the stone dust from above, the dust falls onto one or more plates that support or hold a filter, preventing the stone dust from falling into the air supply duct. The panels are preferably perforated. The stone mud or stone dust lies on the filter, which is preferably made of paper or solid materials and is preferably located between the plates. The container is covered at the top by a funnel-shaped hood with an exhaust pipe and another filter so that no dust that is thrown up can escape upwards. When the dust is to be emptied, the top filter is removed and the whole mechanism is rotated 180° vertically and opened, and the CO2-enriched dust falls out of the container.

Alternatively, via conventional CO2 separation from the air using electrical energy and filter materials, the separated and collected CO2 can also be fed into a closed container that is filled with an aqueous solution of stone dust-stone mud. The CO2 is pumped directly into the stone mud with a nozzle under a correspondingly high pressure and is kept under pressure by the closed system, which prevents the CO2 solution from escaping from the stone mud and accelerates the weathering accordingly. When the weathering process is complete, the rock mud is dried and is in the form of weathered rock dust.

A certain proportion of CO2 from the ambient air is now bound in the stone dust. The stone dust, which has been weathered at an accelerated rate, can now be used as fertilizer on fields or taken to earth storage facilities, which store the stone material containing CO2 in caverns. Applied as a fertilizer on agricultural land, the stone dust weathers completely by further absorbing CO2 from the ambient air and also makes it easier for the soil to absorb CO2 from the ambient air and additionally applied biochar and the carbon it contains, according to the latest scientific findings. Overall, this means a high potential for valuable CO2 negative emissions, which is why the importance of this relatively simple invention is to be underestimated, since it ensures a high degree of weathering of stone flour with relatively little energy, the process of accelerated weathering.

The present invention thus proposes a cost-effective way to produce CO2 negative emissions using stone dust as waste, which is produced more or less free of charge in stone production by cutting stone slab ware, which with the ever-increasing quantities of natural stone materials, that will be installed in the construction sector in the future.

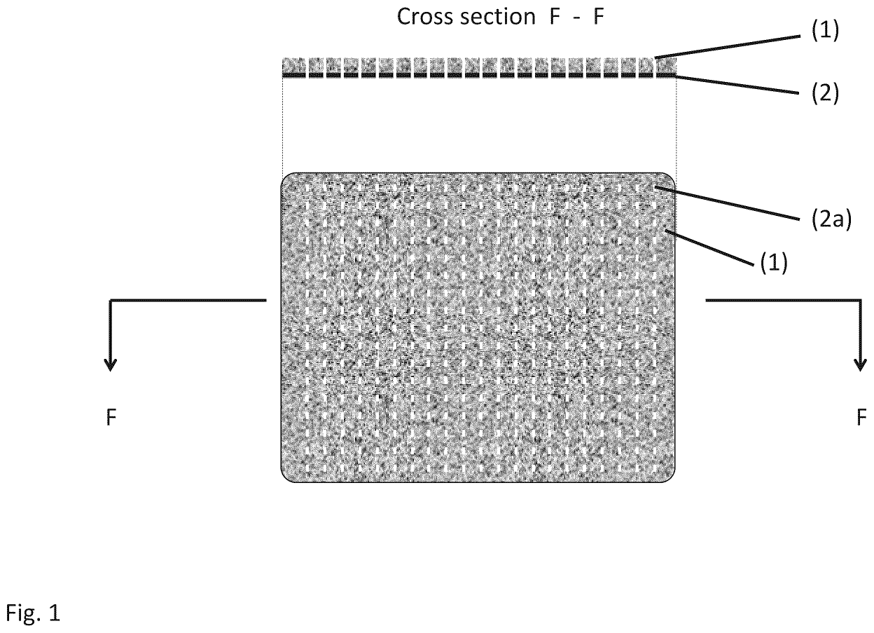

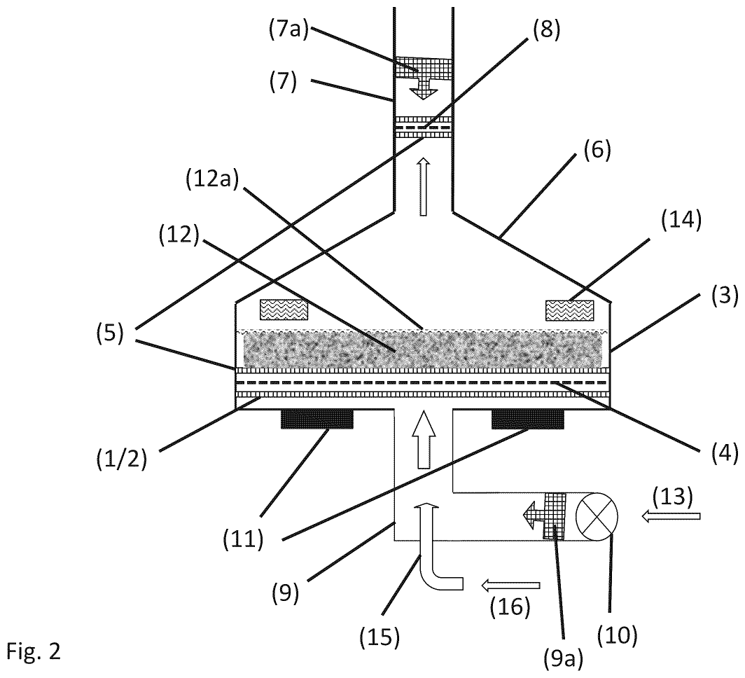

One of the many possible embodiments is shown in FIG. 1 and FIG. 2. FIG. 2 shows the arrangement in cross section.

The illustrations show a stone slab (1) that is flat on the underside and is stabilized with a carbon layer (2) consisting of fiber and resin matrix.

The plate is in a box-shaped container (3). The stone slab (1) is perforated with small holes (2a). On top of the plate lies a paper filter or a sheet of other waterproof and water-permeable material (4), which is pressed onto the stone slab (1) by another perforated plate (5). Above the plate arrangement (1) and (5) is the moist stone dust (12), through which the ambient air or CO2 (13) is pressed or blown from below or, in the case of the ambient air, if necessary. also circulates freely if the exhaust pipe (7) is long enough. In the case of the aqueous stone dust solution for absorbing high-pressure compressed CO2, (12a) indicates the water level of the aqueous stone dust solution. The container (3) has a funnel-shaped outlet (6) with an exhaust pipe (7), pressure control and shut-off (7a) and another filter (8) on the upper side.

At the bottom of the container there is a ventilation tube (9) with a pressure control (9a), through which the ambient air or CO2 (13) is supplied with a blower (10) and a mechanism (11) to induce high-frequency vibrations in the plates offset. In the case of carbonic acid weathering, the unit (11) is not an air blower but a pressure generator or turbine to compress CO2 to high pressure, which is forced into the aqueous stone dust solution. It may be useful to be able to adapt and vary the vibration frequencies of the vibrating mechanism to different consistencies of dust and to be able to adjust in relation to the degree of drying of the sludge or dust. The vibrations accelerate the weathering.

Since the stone sludge is partly produced by cutting the stone with the help of steel saws, it can make sense to filter the metal components from the sludge or dust with the help of a magnet at a suitable point in the process. This can be done with strong static magnets or electromagnets (14).

If the material is freed from harmful metals and heavy metals, it can be used as fertilizer. A nozzle (15) supplies water or steam (16) when the stone dust becomes too dry.

Alternatively, both approaches can be used, filtering CO2 out of the air via the rock mud and at the same time and additionally directing concentrated CO2 over the rock mud as a filter that absorbs the concentrated CO2.

1) Arrangement as a device for aerating solid, dusty and moistened materials with ambient air or CO2, characterized in that the materials serving as a chemical filter consist of ground natural stone—hereinafter referred to as stone dust—around which air flows or flows through to CO2 filter or is in an aqueous solution to absorb CO2.

2) Arrangement according to claim 1, characterized in that the stone dust materials are held by one or more plates with a mechanical filter.

3) Arrangement according to claim 2, characterized in that the plates are perforated.

4) Arrangement according to claim 1, characterized in that the filter material is arranged between the plates.

5) Arrangement according to claim 1, characterized in that the filter consists of paper or a waterproof material.

6) Arrangement according to one of claim 1, characterized in that the filter separates the air or CO2 flowing in through a pipe in concentrated form and the stone dust.

7) Arrangement according to one of claim 1, characterized in that the plates are made of carbon fiber brick.

8) Arrangement according to one of claim 1, characterized in that the plates are surrounded by a box which encloses the arrangement airtight, wherein the box or container is pressure-resistant for pressure from the inside.

9) Arrangement according to one of claim 1, characterized in that the plates or another device of a vibrating mechanism put the stone dust into high-frequency mechanical vibrations.

10) Arrangement according to one of claim 1, characterized in that the inflowing air is humidified with water or water vapor or CO2 is supplied under pressure into the interior of the box or container.

11) Arrangement according to one of claim 1, characterized in that the arrangement can be pivoted vertically through 180° and opened.

12) Arrangement according to one of claim 1, characterized in that the stone dust consists of granite, gneiss, gabbro, serpentine, olivine, dunite or basalt or a mixture of these materials.

13) Arrangement according to one of claim 1, characterized in that the vibrating vibration mechanism has a frequency control.

14) Arrangement according to one of claim 1, characterized in that metallic components are removed with the aid of a magnet from the stone dust.

15) Arrangement according to one of claim 1, characterized in that there is a pressure-regulating valve in each case in the air or CO2 supply pipe and/or exhaust gas pipe.

16) Arrangement according to one of claim 1, characterized in that the rock dust is used as fertilizer for agriculture and/or oceans.
